(19) United States
(12) Patent Application Publication
(10) Pub. No.: US 2015/0193555 A1
(43) Pub. Date: Jul. 9, 2015

(54) Method and device for pushing media information in real time

(71) Applicant: TENCENT TECHNOLOGY (SHENZHEN) COMPANY LIMITED, Shenzhen, Guangdong (CN)

(72) Inventor: Dewen Wang, Shenzhen (CN)

(21) Appl. No.: 14/411,576

(22) PCT Filed: Sep. 13, 2013
(86) PCT No.: PCT/CN2013/083515

§ 371 Date: Dec. 29, 2014

(30) Foreign Application Priority Data
Sep. 17, 2012 (CN) 201210345450.5

(51) Int. Cl. G06F 17/30

(52) U.S. Cl. CPC G06F 17/30896; G06F 17/30905

(57) ABSTRACT

It is described a method for pushing media information in real time, where information of user focus on a current page is determined, a keyword is searched for according to the information of user focus, and media information matching the found keyword is pushed in real time. It is also described a device for pushing media information in real time. With what described, it is possible to improve real-time performance and accuracy in pushing media information.

The present application claims the priority of CN application No. 201210345450.5, titled “METHOD AND DEVICE FOR PUSHING MEDIA INFORMATION IN REAL TIME ACCORDING TO INFORMATION OF USER FOCUS” filed on Sep. 17, 2012 by TENCENT Technology (Shenzhen) Company Limited, the disclosure of which is incorporated by reference herein in its entirety.

### TECHNICAL FIELD

The present disclosure relates to the field of internet information release, and in particular to a method and device for pushing media information in real time according to information of user focus.

### BACKGROUND

At present, beside the body of an online article, there is generally an information block, inside which a lot of text or picture information is pushed. Differing from a general bidding rank or text link, the text or picture information inside the information block is associated with context of the article. For example, it is possible to see, beside the body of an article on a most recent car, an information block related to the car sale or service.

Content of an article may be fetched and analyzed in an earlier stage, such that text or picture information associated with the content of the article is defined, and fixedly pushed so as to be shown in an information block beside the body of the article. However, this does not mean that a user will look at or see the whole content of the article. The user may care for content of only a section of the article or some other content. Thus, when the article is browsed, what shown in the information block beside the body will always be the text or picture information associated with the whole content of the article, thereby failing to accurately push information associated with information of user focus.

### SUMMARY

In view of this, it is desired that embodiments of the present disclosure provide a method and device for pushing media information in real time, capable of improving real-time performance and accuracy in pushing media information.

To this end, a technical solution of an embodiment of the present disclosure is implemented as follows.

A method for pushing media information in real time provided by an embodiment of the present disclosure includes steps of: determining information of user focus on a current page; and pushing, in real time, media information matching the information of user focus.

A device for pushing media information in real time provided by an embodiment of the present disclosure includes an information-of-user-focus determining module and a real-time pushing module,

the information-of-user-focus determining module is configured for determining information of user focus on a current page, and

the real-time pushing module is configured for pushing, in real time, media information matching the information of user focus.

Embodiments of the present disclosure provide a method and device for pushing media information in real time, where information of user focus on a current page is determined, and media information matching the information of user focus is pushed in real time. It is thus possible to improve real-time performance and accuracy in pushing media information.

### BRIEF DESCRIPTION OF THE DRAWINGS

FIG. 1 is a flowchart of a method for pushing media information in real time based on information of user focus according to an embodiment of the present disclosure; and

FIG. 2 is a schematic diagram of a structure of a device for pushing media information in real time based on information of user focus according to an embodiment of the present disclosure.

### DETAILED DESCRIPTION

In an embodiment of the present disclosure, information of user focus on a current page is determined, and media information matching the information of user focus is pushed in real time. The media information may be information such as text or a picture.

The present disclosure is further elaborated below with reference to drawings and specific embodiments.

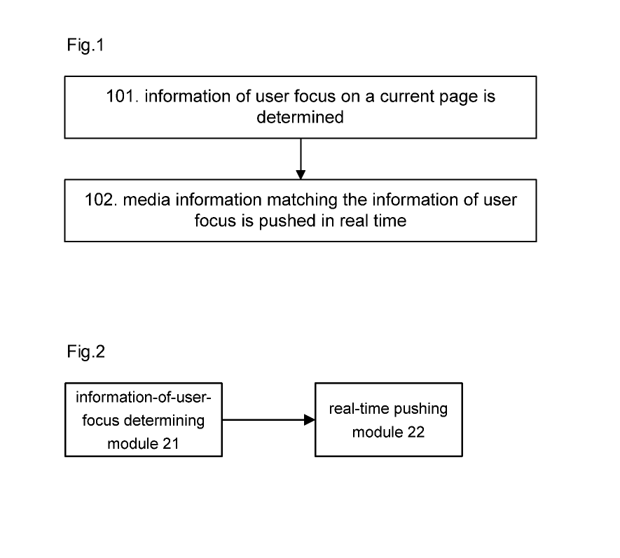

An embodiment of the present disclosure provides a method for pushing media information in real time based on information of user focus. As shown in FIG. 1, the method includes steps as follows.

In step 101, information of user focus on a current page is determined.

In an embodiment, a computer background may acquire an offset height of each element in content of a webpage browsed by a user and an offset height of an element shown in the current page, and determine, according to the offset height of each element in the content of the webpage browsed by the user and the offset height of the element shown in the current page, content or an identity (ID) of the element shown in the current page as the information of user focus on the current page.

The computer background may acquire the offset height of each element in the content of the webpage browsed by the user and the offset height of the element shown in the current page by: loading the content of the webpage by the computer background; when the user browses the content of the webpage and stays at an arbitrary position on a page, acquiring, via an element-top acquiring function, the offset height of each element in the content of the webpage; acquiring, via a page acquiring function, a size of the webpage and a size of the page; acquiring, via a scrollbar-position acquiring function, a position of a scrollbar on the current page; acquiring, according to the offset height of each element in the content of the webpage, the size of the webpage and the size of the page, and the position of the scrollbar on the current page, the offset height of the element shown in the current page. The content of the webpage includes content posted in a micro-blog or a forum by a user.

An aforementioned element may be independent information in the webpage, such as micro-blog content by a user or a comment or reply by a user in a page.

In a micro-blog scenario, step 101 may be divided into steps as follows.

In step 201, when the user browses a micro-blog and stays at an arbitrary position on a page, the computer background may acquire, via an element-top acquiring function getElementTop, the offset height of each micro-blog. For example, the offset height of the first micro-blog may be acquired as follows:

>>getElementTop (document.getElementByID(‘46258092435294’))

408,

where ‘46258092435294’ may be the ID of the first micro-blog, 408 may be the obtained offset height of the first micro-blog.

In step 202, a size of the webpage and a size of the page may be obtained via a page acquiring function GetPageSize:

>>GetPageSize( )
{

PageW: 1419,
PageH: 8464,
WinW: 1419,
WinH: 770

},

where PageW denotes an obtained webpage width, PageH denotes an obtained webpage height, WinW denotes an obtained display width, WinH denotes an obtained display height.

In step 203, a position of a scrollbar on the current page is obtained via a scrollbar-position acquiring function GetPageScroll:

>>GetPageScroll( )
{

X: 0,
Y: 231

},

where X denotes the position of a horizontal scrollbar, Y denotes the height of a vertical scrollbar.

In step 204, the information of user focus on a current micro-blog page is obtained.

Assume that the offset height of the first micro-blog is W1, the height of each micro-blog other than the first micro-blog is WHi, the height of a vertical scrollbar on the current page is S, and a page height is WH; then the offset height WHx of a micro-blog shown in the current page should meet a condition min(S,W1)<WHx<S+WH. At least one WHx meeting the condition is obtained via formula (1), where x denotes the x^{th} micro-blog; and the content or the ID of the x^{th} micro-blog is the information of user focus on the current page.

$$WHx = W 1 + {\sum }_{i = 2}^{x} WHi \qquad ( 1 )$$

The step may further include that: pre-recorded via an operation habit database is an operation position on a page where the user operates each element in the content of the webpage; a most probable operation position is found by statistics; after an element shown in the current page is determined, an element the user focuses on is determined according to the most probable operation position; the content or the ID of the element the user focuses on is the information of user focus on the current page.

In step 102, media information matching the information of user focus is pushed in real time.

In an embodiment, a keyword is searched for according to the information of user focus; and the media information matching the found keyword is pushed in real time.

The keyword may be found according to the information of user focus specifically by: determining, by the computer background, content shown in the current page according to the information of user focus; performing semantic analysis on the content shown in the current page; and finding the keyword matching a keyword in a media database. The media database may be a preset database storing media information and a keyword corresponding to the media information.

The media information matching the found keyword may be pushed in real time specifically by: pushing, by the computer background, media information in the media database in real time, wherein the pushed media information in the media database matches the found keyword.

In the step, the computer background may push, in real time, media information in the media database that matches the found keyword by: suspending or embedding the media information in the media database that matches the found keyword, at a position with preset coordinates where media information is to be shown on a page.

To implement an aforementioned method, an embodiment of the present disclosure further provides a device for pushing media information in real time according to information of user focus. As shown in FIG. 2, the device includes an information-of-user-focus determining module 21 and a real-time pushing module 22.

The information-of-user-focus determining module 21 is configured for determining information of user focus on a current page.

The real-time pushing module 22 is configured for pushing, in real time, media information matching the information of user focus.

The information-of-user-focus determining module 21 may specifically be configured for: acquiring, via a computer background, an offset height of each element in content of a webpage browsed by a user and an offset height of an element shown in the current page; and determining, according to the offset height of each element in the content of the webpage browsed by the user and the offset height of the element shown in the current page, content or an ID of the element shown in the current page as the information of user focus on the current page.

The real-time pushing module 22 may specifically be configured for: searching for a keyword according to the information of user focus; and pushing, in real time, the media information matching the found keyword.

In an embodiment, the real-time pushing module 22 may be configured for: determining content shown in the current page according to the information of user focus; performing semantic analysis on the content shown in the current page; finding the keyword matching a keyword in a media database; and pushing media information in the media database in real time, wherein the pushed media information in the media database matches the found keyword.

When implemented in form of a software functional module and sold or used as an independent product, the method for pushing media information in real time according to an embodiment of the present disclosure may also be stored in a non-transitory computer-readable storage medium. Based on such an understanding, the essential part or a part contributing to prior art of the technical solution of an embodiment of the present disclosure may appear in form of a software product which is stored in storage media and includes a number of instructions for allowing a computer equipment (such as a personal computer, a server, a network equipment, or the like) to execute all or part of the methods in various embodiments of the present disclosure. The storage media include various media that can store program codes such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the present disclosure further provides a computer storage medium storing a computer program for executing the method for pushing media information in real time according to information of user focus according to an embodiment of the present disclosure.

To sum up, with an embodiment of the present disclosure, media information is pushed in real time according to the information of user focus, thereby improving real-time performance and accuracy in pushing media information.

What describe are merely embodiments of the present disclosure, and are not intended to limit the scope of the present disclosure.

1. (canceled)

2. A method for pushing media information in real time, comprising:
acquiring, by a computer background, an offset height of each element in content of a webpage browsed by a user and an offset height of an element shown in the current page;
determining, according to the offset height of each element in the content of the webpage browsed by the user and the offset height of the element shown in the current page, content or an ID of the element shown in the current page as the information of user focus on the current page; and
pushing, in real time, media information matching the information of user focus.

3. The method according to claim 2, wherein the acquiring, by a computer background, an offset height of each element in content of a webpage browsed by a user and an offset height of an element shown in the current page comprises:
loading, by the computer background, the content of the webpage;
when the user browses the content of the webpage and stays at an arbitrary position on a page, acquiring, via an element-top acquiring function, the offset height of each element in the content of the webpage;
acquiring, via a page acquiring function, a size of the webpage and a size of the page;
acquiring, via a scrollbar-position acquiring function, a position of a scrollbar on the current page; and
acquiring, according to the offset height of each element in the content of the webpage, the size of the webpage and the size of the page, and the position of the scrollbar on the current page, the offset height of the element shown in the current page.

4. The method according to claim 3, wherein the pushing, in real time, media information matching the information of user focus comprises:
searching for a keyword according to the information of user focus; and
pushing, in real time, the media information matching the found keyword.

5. The method according to claim 4, wherein the searching for a keyword according to the information of user focus comprises:
determining, by the computer background, content shown in the current page according to the information of user focus;
performing semantic analysis on the content shown in the current page; and
finding, from the information obtained through the semantic analysis, the keyword matching a keyword in a media database.

6. The method according to claim 5, wherein the pushing, in real time, the media information matching the found keyword comprises:
pushing, by the computer background, media information in the media database in real time, wherein the pushed media information in the media database matches the found keyword.

7. The method according to claim 2, wherein the content of the webpage comprises content posted in a micro-blog or a forum by a user.

8. (canceled)

9. A device for pushing media information in real time, comprising:
an information-of-user-focus determining module, configured to: acquire, via a computer background, an offset height of each element in content of a webpage browsed by a user and an offset height of an element shown in the current page; and determine, according to the offset height of each element in the content of the webpage browsed by the user and the offset height of the element shown in the current page, content or an ID of the element shown in the current page as the information of user focus on the current page; and
a real-time pushing module, configured to push, in real time, media information matching the information of user focus.

10. The device according to claim 9, wherein the real-time pushing module is configured to: search for a keyword according to the information of user focus; and push, in real time, the media information matching the found keyword.
